(19) United States
(12) Patent Application Publication
(10) Pub. No.: US 2025/0343598 A1
(43) Pub. Date: Nov. 6, 2025

(54) PRECONFIGURED UPLINK RESOURCE SHARING IN NON-TERRESTRIAL NETWORKS

(71) Applicant: InterDigital Patent Holdings, Inc., Wilmington, DE (US)

(72) Inventors: Dylan Watts, Montreal (CA); Brian Martin, Farnham (GB); Moon-il Lee, Melville, NY (US); Paul Marinier, Brossard (CA); Faris Alfarhan, Montreal (CA); Oumer Teyeb, Montreal (CA); Umer Salim, Vallauris (FR); Keiichi Kubota, Tokyo (JP)

(73) Assignee: InterDigital Patent Holdings, Inc., Wilmington, DE (US)

(21) Appl. No.: 18/655,865

(22) Filed: May 6, 2024

(51) Int. Cl. H04B 7/185; H04W 72/04

(52) U.S. Cl. CPC H04B 7/18513; H04W 72/04

(57) ABSTRACT

Systems, methods, devices, and instrumentalities are described herein related to configured (e.g., pre-configured) uplink resource sharing in non-terrestrial networks (NTNs). A wireless transmit/receive unit (WTRU) may be configured to receive a first preconfigured uplink resource (PUR) configuration from a first NTN cell. The first PUR configuration may indicate whether at least one resource is available on the first NTN cell and/or a second NTN cell. The WTRU may select the second NTN cell. The WTRU may receive a second PUR configuration from the second NTN cell. The second PUR configuration may include at least one of a dedicated PUR resource or a shared PUR resource. Based on the first PUR configuration and the second PUR configuration, the WTRU may determine whether a dedicated PUR resource is available. Based on a determination, the WTRU may transmit an early data transmission (EDT) request using the dedicated PUR resource.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to configured (e.g., preconfigured) uplink resource sharing in non-terrestrial networks (NTNs).

A device (e.g., a target wireless transmit/receive unit (WTRU) may be configured to receive a preconfigured uplink resource (PUR) configuration from a first NTN cell. For example, the device may receive a first PUR configuration from the first NTN cell. The first PUR configuration may indicate whether at least one resource is available. For example, the first PUR configuration may indicate whether at least one resource is available on the first NTN cell and/or a second NTN cell.

The WTRU may select the second NTN cell. The WTRU may receive a second PUR configuration from the second NTN cell. The second PUR configuration may include at least one of a dedicated resource (e.g., a dedicated PUR resource) or a shared resource (e.g., a shared PUR resource). Based on the first PUR configuration and the second PUR configuration, the WTRU may determine whether a dedicated PUR resource is available. Based on a determination that the dedicated PUR resource is available, the WTRU may transmit an early data transmission (EDT) request using the dedicated PUR resource.

The first PUR configuration may include at least one of a list of cells associated with the second NTN cell, periodicity information that is associated with the determination that the resource is available, an index associated with the resource, or an indication indicative of a number of WTRU-identification (ID) bit to be used for the determination that the resource is available.

The WTRU may send a request to the first NTN cell. The request may include information associated with periodicity, occurrence, transform block size (TBS), or a radio resource control (RRC) acknowledgement (ACK) preference.

In examples, the WTRU may determine whether the dedicated PUR resource is available (e.g., valid) by determining that the dedicated PUR resource is associated with (e.g., included in) the first PUR configuration and the second PUR configuration. In examples, the WTRU may determine whether the dedicated PUR resource is available by determining that the dedicated PUR resource matches an index or a WTRU-ID indicated in the first PUR configuration and the second PUR configuration. In examples, the WTRU may determine whether the dedicated PUR resource is available by determining that the dedicated PUR resource satisfies a condition indicated in the first PUR configuration and the second PUR configuration. The condition may include at least one of whether the WTRU has estimated a valid timing advance (TA) or has a valid TA available, location, a time, a radio quality condition, and/or the like.

The first PUR configuration may include a preconfigured uplink resource from the first NTN cell.

The first PUR configuration may be received in at least one of a RRC release message, a broadcast configuration message.

Based on the determination that the dedicated resource (e.g., the dedicated PUR resource) is unavailable, the WTRU may determine whether the shared resource (e.g., the shared PUR resource) is available. Based on a determination that the shared PUR resource is available, the WTRU may select the shared PUR resource. For example, the WTRU may select the shared PUR resource based on at least one of a list of shared PUR resources, a WTRU ID, or satisfying a condition. The condition may include at least one a location, a time, or a radio quality condition. The WTRU may transmit the EDT request using the shared PUR resource. The WTRU may select the shared PUR resource based on the on the first PUR configuration and the second PUR configuration.

Based on a determination that the dedicated resource (e.g., the dedicated PUR resource) is unavailable, the WTRU may determine whether the shared resource (e.g., the shared PUR resource) is available. Based on a determination that the shared PUR resource is unavailable or if the WTRU detects a failure associated with a connection, the WTRU may perform a radio access channel procedure for an EDT transmission.

The WTRU may receive a termination indication, e.g., after performing the EDT transmission. The termination indication may include at least one of a layer 1 (L1) ACK message, a medium access control (MAC) control element (CE), or an RRC early data complete message. For example, if the WTRU receives the termination indication, the WTRU may transition to a different state (e.g., an IDLE state).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates example interfaces in a non-terrestrial network (NTN).

FIG. 3 illustrates example signaling related to preconfigured uplink resource (PUR) configuration.

FIG. 4 illustrates an example transmission using PUR for a control plane.

FIG. 5 illustrates example signaling in an NTN.

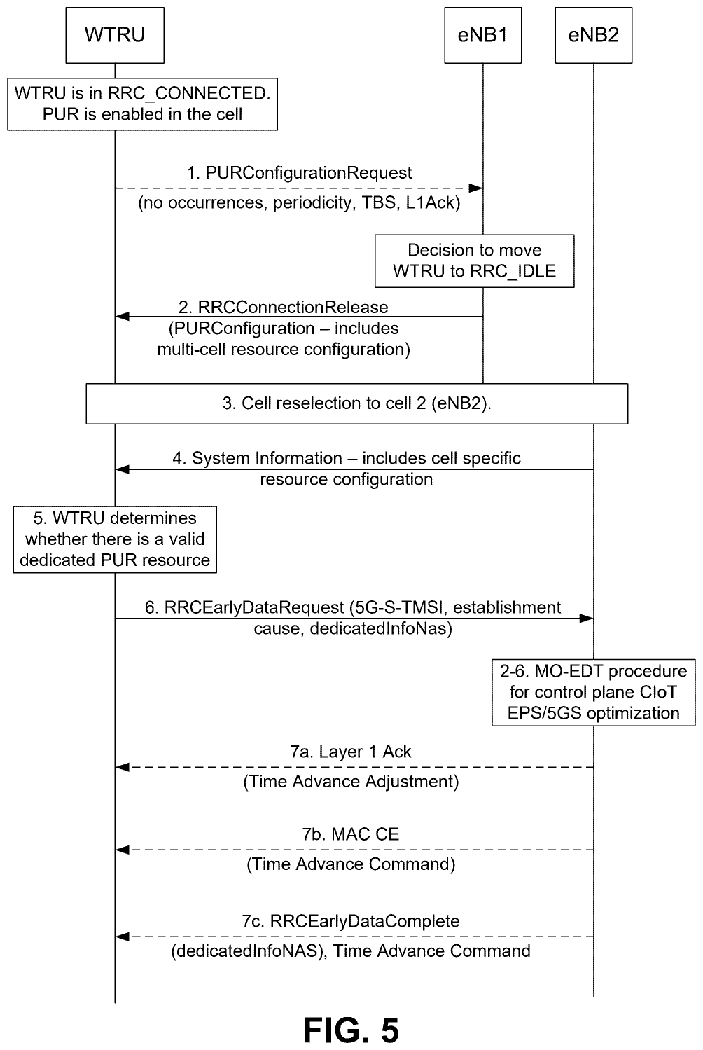

### DETAILED DESCRIPTION

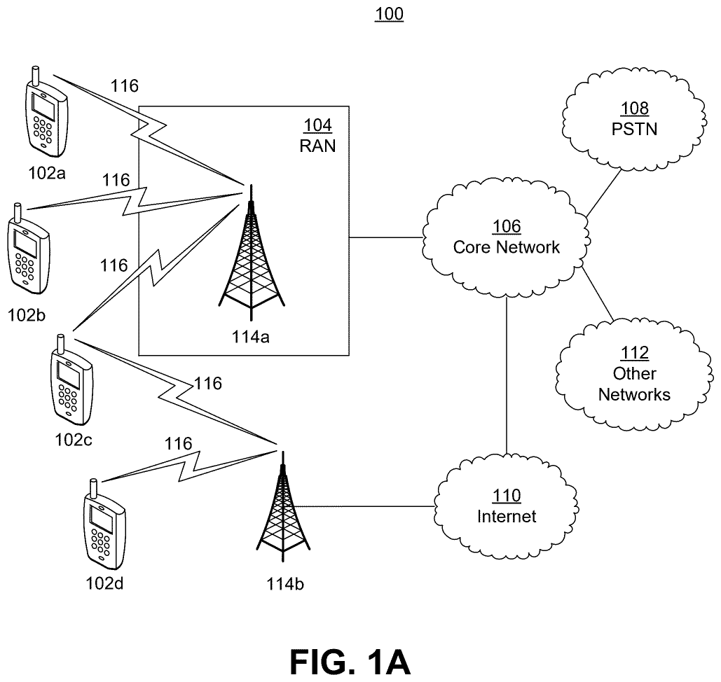

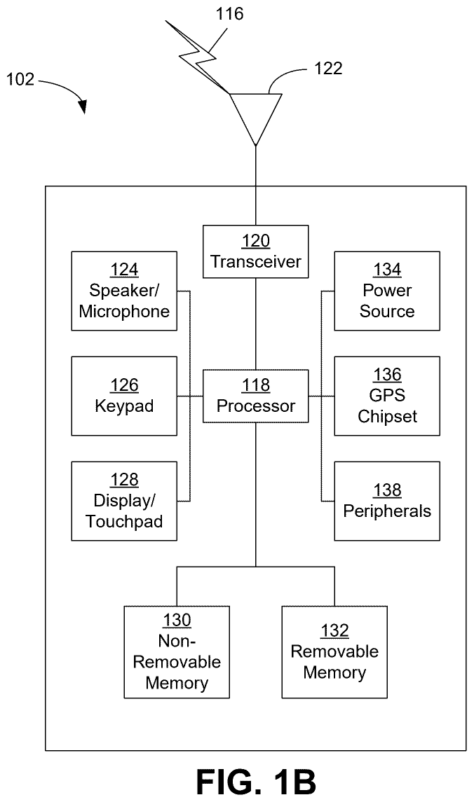

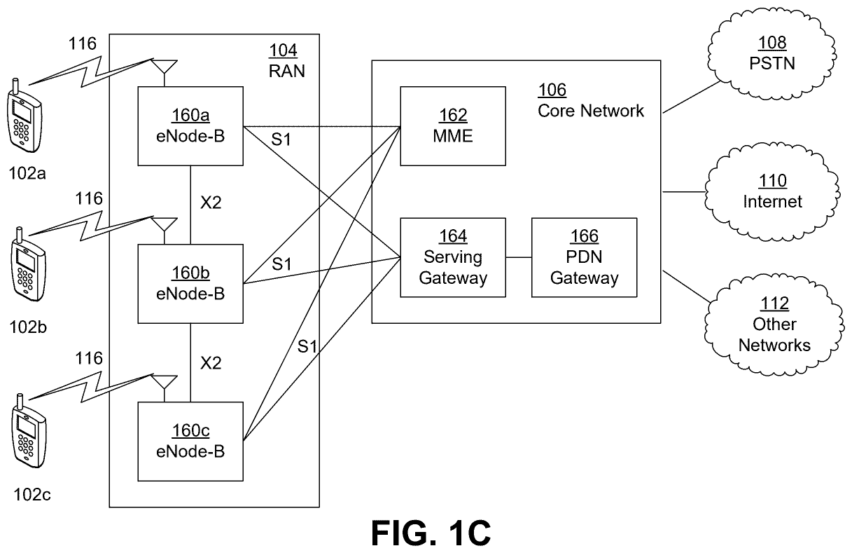

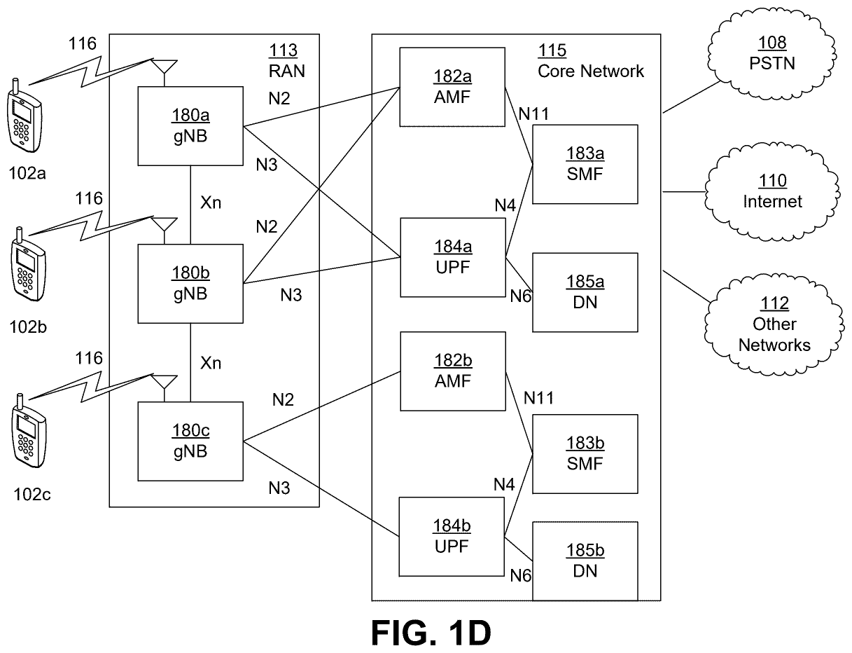

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more examples described herein may be associated with Non-terrestrial networks (NTN).

An NTN (e.g., a basic NTN) may include an aerial or space-borne platform which, via a gateway (GW), may transport signals from a land-based based base station, such as a gNB, to a WTRU and vice-versa. An NTN may support a power class 3 WTRU with an omnidirectional antenna and linear polarization, or a very small aperture antenna (VSAT) terminal with a directive antenna and circular polarization. LTE-based narrow-band IoT (NB-IoT) and eMTC type devices may be provided herein. Regardless of device type, one or more NTN WTRUs may be global navigation satellite system (GNSS) capable.

Aerial or space-borne platforms may be classified in terms of orbit, which may be low-earth orbit (LEO) satellites with altitude ranges of 300-1500 km, for example, and geostationary earth orbit (GEO) satellites with altitudes at 35-786 km, for example. Platform classifications may be provided such as medium-earth orbit (MEO) satellites with altitude ranges of 7000-25000 km, for example, and high-altitude platform stations (HAPS) with altitudes of 8-50 km, for example. Satellite platforms may be classified (e.g., further classified) as having a transparent or regenerative payload. Transparent satellite payloads may implement frequency conversion and RF amplification in both uplink and downlink, with multiple transparent satellites possibly connected to a land-based gNB (e.g., one land-based gNB). Regenerative satellite payloads may implement either a full gNB or gNB DU onboard the satellite. Regenerative payloads may perform digital processing on the signal including demodulation, decoding, re-encoding, re-modulation, and/or filtering.

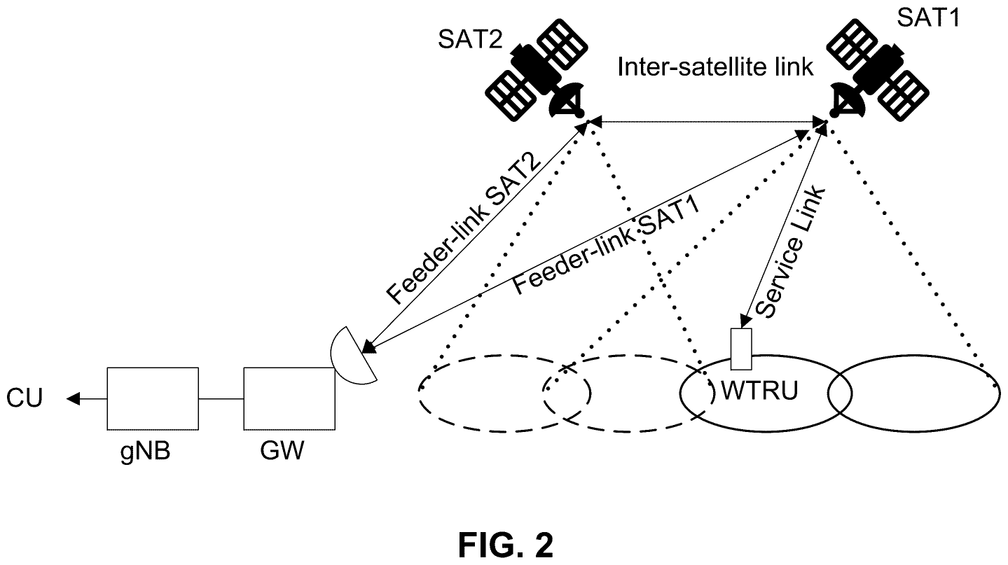

FIG. 2 illustrates an example of different interfaces in a non-terrestrial network. Example radio interfaces may include: a feeder-link (e.g., a wireless link between the GW and satellite); a service link (e.g., a radio link between the satellite and WTRU); and/or an inter-satellite link (ISL) (e.g., a transport link between satellites). The ISL may be supported by regenerative periods (e.g., only by regenerative payloads) and may be a 3GPP radio or proprietary optical interface.

An NTN satellite may support one or more (e.g., multiple) cells. A (e.g., each) cell may include one or more satellite beams. Satellite beams may cover a footprint on the Earth (e.g., like a terrestrial cell). Satellite beams may range in diameter. For example, a satellite beam may range from 100-1000 km in LEO deployments. Beam footprints in LEO deployments may change over time due to satellite movement. A satellite beam may range from 200-3500 km diameter in GEO deployments. Beam footprints in GEO deployments may remain fixed relative to the Earth. Beam movement may be classified as Earth moving (e.g., in LEO deployments where the beam moves continuously across the Earth). Beam movement may be classified as Earth fixed (e.g., in GEO deployments where the beam is steered to remain covering a fixed location until a new cell overtakes the coverage area).

The round-trip time (RTT) and maximum differential delay of NTNs may be larger than that of terrestrial systems. This may be due to the altitude of NTN platforms and beam diameter. For example, in a transparent NTN deployment, RTT may range from 25.77 milliseconds (e.g., for a LEO deployment at an altitude of 600 km) to 541.46 milliseconds (e.g., for a GEO deployment). The maximum differential delay in a transparent NTN deployment may range from 3.12 milliseconds to 10.3 milliseconds.

The RTT of a transparent configuration may be based on the service and feeder links. The RTT of a regenerative payload may be based on the service link (e.g., only on the service link). The RTT of a regenerative payload may be approximately half that of a transparent payload. Prior to initial access, a WTRU may perform timing pre-compensation. This may help minimize (e.g., or at least reduce) impact on existing NR systems (e.g., by avoiding preamble ambiguity or properly timing reception windows).

As part of the timing pre-compensation, the WTRU may obtain its position via GNSS. The WTRU may obtain the feeder-link delay (e.g., or a common delay). The WTRU may obtain a satellite position (e.g., via satellite ephemeris data). The satellite ephemeris data may be broadcast (e.g., periodically broadcast) in system information. The satellite ephemeris data may include speed, direction, and/or velocity associated with the satellite. The WTRU may estimate the distance and/or delay from the satellite. The WTRU may add the feeder-link delay component to the estimated delay to obtain the full WTRU-to-gNB RTT. The full WTRU-to-gNB RTT may be used to offset communication timing (e.g., timers, reception windows, and/or timing relations). The network may perform frequency compensation.

In NTNs, the difference in reference signal received power (RSRP) between cell center and cell edge may not be as pronounced as in terrestrial systems. There may be a larger region of cell overlap in NTNs compared to terrestrial systems. Measurement-based mobility may become less reliable in an NTN environment. NTNs may utilize conditional handover and/or measurement reporting triggers relying on location and time. Enhanced mobility techniques may be of particular interest in LEO deployments. For example, in LEO deployments, due to satellite movement, even a stationary WTRU may be expected to perform mobility periodically, e.g., approximately every 7 seconds. The frequency of the mobility checks may be based on deployment characteristics.

Transmissions may use a preconfigured uplink resource (PUR).

Transmissions using a PUR may allow an (e.g., one) uplink transmission from RRC_IDLE using a preconfigured uplink resource (e.g., without performing the random access procedure).

Transmissions that use a PUR may be enabled by the (ng-) eNB (e.g., if the WTRU and the (ng-) eNB support using a PUR).

The WTRU may request a PUR. For example, the WTRU may be configured with requesting a PUR. The WTRU may request to have a PUR configuration released (e.g., while in RRC_CONNECTED mode). The (ng-) eNB may decide to configure a PUR based on the request of the WTRU, the subscription information associated with the WTRU, the local policy associated with the WTRU, and/or the like. The PUR may be valid (e.g., only valid) in the cell in which the configuration was received.

A transmission using a PUR may be triggered if/when the upper layers request the establishment or resumption of the radio resource control (RRC) Connection, the WTRU has a valid PUR for transmission, and/or the WTRU meets TA validation criteria.

Example PUR configuration requests and PUR configurations may be provided herein. FIG. 2 illustrates an example PUR configuration request and PUR configuration.

PUR configuration requests and PUR configurations may be used (e.g., for optimization) in the Control Plane cellular internet of things (CIoT) and the User Plane (e.g., as illustrated in FIG. 2).

A transmission using PUR may be used (e.g., for optimization) for the Control Plane.

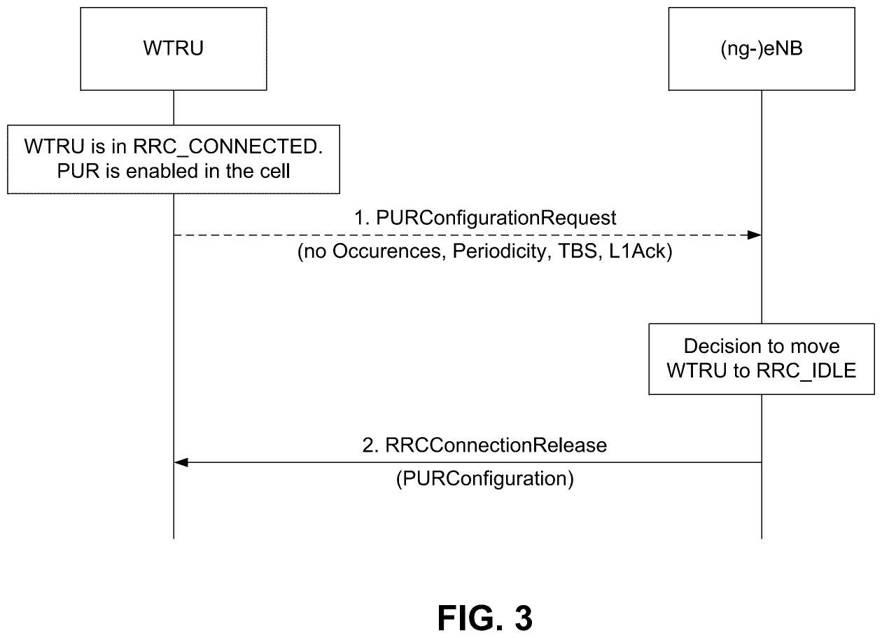

FIG. 3 illustrates example signaling related to preconfigured uplink resource (PUR) configuration (e.g., the procedure for transmission using PUR for the Control Plane CIoT EPS optimization and for the Control Plane CIoT 5GS optimization).

Uplink capacity may be enhanced using PUR in an NTN deployment.

NB-IoT NTN(s) may be deployed. NB IoT NTN uplink (UL) system capacity may be limited by the corresponding system downlink (DL) capacity (e.g., due to the larger signaling overhead in the downlink (up to ˜53%) and/or the tight coupling between UL and DL signaling). This may impact the UL driven traffic (e.g., predominantly UL driven traffic), such as mobile originated (MO) transmissions (e.g., which may be the target of massive IoT and initial emergency messaging use cases supported by IoT NTN). To unlock additional UL capacity potential, the UL may be decoupled from the DL (e.g., as much as possible). Improving system capacity via reduced DL signaling and techniques such as contention-based PUR and orthogonal cover code (OCC) may be used to meet the capacity demands and increase economic viability.

Uplink capacity in IoT NTNs may be configured (e.g., improved).

Uplink and downlink signaling (e.g., necessary uplink and downlink signaling) may be reduced to complete an early data transmission (EDT) transaction. For example, a Msg3 transmission without msg1/Random Access Response (RAR) may be used.

Example(s) associated with efficient delivery (e.g., reduced overhead) of msg4 and/or RRCEarlyDataComplete are provided herein.

The performance of EDT may be configured (e.g., improved). For example, the performance of EDT may be improved using the preconfigured uplink resource (PUR) example described herein.

Msg3 transmission without msg1/RAR may be supported in networks with PUR.

EDT with PUR may have limitation(s) in an NTN context related to the applicability of PUR.

The WTRU may be configured with dedicated resources (e.g., only dedicated resource) to use for EDT with PUR. A shared resource may not be provided via dedicated or broadcast signaling (e.g., to improve uplink capacity).

The WTRU may move to RRC_CONNECTED, e.g., before the PUR is configured. The PUR may be applicable (e.g., only applicable) in the cell in which the configuration was received. In an NTN (e.g., especially LEO), frequent cell changes may cause PUR resources to not be valid (e.g., unavailable) for long enough to be of use (e.g., because it's not possible to configure PUR resources across cells).

A device (e.g., a WTRU) may determine a PUSCH resource on an NTN cell based on configuration on a previous cell. The WTRU may receive dedicated configuration of a preconfigured uplink resources from a previous cell. The WTRU may determine (e.g., based on broadcast information on the new cell) a specific dedicated resource to use. The WTRU may determine to use a shared resource (e.g., a contention based PUSCH) if no dedicated configuration was received or if the dedicated resource is not valid in the new cell.

The WTRU may transmit a request, such as a PUR configuration request, to an NTN cell, e.g., a first NTN cell. The PUR configuration request may include an indication of one or more of: periodicity, no occurrences, transport block size (TBS), whether an RRC acknowledgement (ACK) is preferred, and/or the like.

The WTRU may receive a configuration, such as a PUR configuration (e.g., enhanced PUR Configuration in RRC Release). The PUR configuration, e.g., the first PUR configuration, may include a preconfigured uplink resource from an NTN cell, e.g., a first NTN cell. The PUR configuration may include an indication that the resource is valid (e.g., available) on one or more second cells (e.g., second NTN cells). The PUR configuration (e.g., the first PUR configuration) may include: an explicit list of cells (e.g., physical cell ID (PCI); a periodicity that may be used to implicitly determine of valid cells (e.g., based on satellite ephemeris information and/or PUR periodicity); an index for a resource (e.g., index X); an indication of a number of WTRU-ID bits to use for determining whether a resource is valid (e.g., available); and/or the like.

The WTRU may perform reselection to a second NTN cell. For example, the WTRU may select a second NTN cell.

The WTRU may receive a broadcast PUR configuration from the second cell (e.g., including dedicated and shared PUR resources). For example, the WTRU may receive a second PUR configuration from the second NTN cell.

The WTRU may determine (e.g., based on the configurations received from the first and second cell) whether the dedicated resource is valid. For example, based on the first PUR configuration and the second PUR configuration, the WTRU may determine whether a dedicated PUR resource is available (e.g., valid).

In examples, the WTRU may determine whether the dedicated resource is valid (e.g., available) based on the cell list (explicitly or implicitly).

In examples, the WTRU may check whether the dedicated resource is valid (e.g., available) based on the signaled index (e.g., from the first PUR configuration and/or the second PUR configuration). In examples, the WTRU may determine whether a valid resource is configured in the second cell based on the WTRU-ID (e.g., a list of dedicated resources may provide resource for some but not all indexes).

In examples, the WTRU may use additional criteria to determine whether the dedicated resource is valid (e.g., available). For example, the WTRU may determine whether the dedicated resource is valid (e.g., available) based on whether the WTRU has estimated a valid timing advance (TA), or has a valid TA available. The WTRU may whether the dedicated resource is valid based on location, time, radio quality conditions, and/or the like.

If the WTRU determines that a valid dedicated resource (e.g., a dedicated PUR resource) is available, the WTRU may transmit an EDT request using the determined PUR (e.g., the determined dedicated PUR resource).

If the WTRU determines that no valid dedicated resource (e.g., a dedicated PUR resource) is available, the WTRU may determine whether a valid shared PUR resource is available. The WTRU may select (e.g., randomly select) a shared resource (e.g., a shared PUR resource) from a list of shared resources (e.g., a list of shared PUR resources). In examples, the WTRU may select a shared resource (e.g., a shared PUR resource) based on WTRU ID. In examples, the WTRU may select a shared resource (e.g., a shared PUR resource) based on one or more additional conditions. For example, the WTRU may select a shared PUR resource based on satisfying one or more additional conditions. The one or more additional conditions may be, or may include, location, time, radio quality conditions, and/or the like.

If the WTRU determines that a valid shared resource (e.g., a shared PUR resource) is available, the WTRU may transmit using the determined PUR resource (e.g., the shared PUR resource). The WTRU may transmit a (e.g., specific) preamble. The WTRU may transmit a payload using PUSCH.

If the WTRU determines that no valid shared resource (e.g., a shared PUR resource) is available (e.g., and no dedicated PUR resource is available), or if the WTRU detects a failure (e.g., contention failure, no ACK, etc.), the WTRU may perform random access channel (RACH) procedure for the EDT transmission.

The WTRU may receive an indication, e.g., after performing the EDT transmission. The indication may be, or may include, L1 ACK, MAC CE, RRCEarlyDataComplete, and/or the like. The indication may be configured to terminate the procedure. For example, if the WTRU transmits the EDT request as described herein, the WTRU may receive an indication, such as a termination indication, as described herein, to terminate the procedure. If the WTRU receives the termination indication, the WTRU may transition to a different state (e.g., an IDLE state).

As described herein, the WTRU may use a dedicated PUR resource, assigned in the first cell (e.g., the first NTN cell) and used in the second cell (e.g., the second NTN cell). The WTRU may use a shared PUR resource, if a dedicated PUR is unavailable (e.g., invalid). The WTRU may use RACH if no PUR has been assigned (e.g., the dedicated PUR resource and the shared PUR resource is unavailable/invalid).

Example(s) described herein may enable PUR in NTN scenarios by enabling configuration of PUR resources across multiple cells.

Example(s) described herein may preserve robustness by allowing dedicated resource to be used (e.g., in some cases). Example(s) described herein may improve uplink capacity by enabling use of shared PUR resources (e.g., in other cases).

Example(s) described herein may allow long term dedicated configuration of a PUR across multiple NTN cells (e.g., while allowing short term per-cell control using broadcast signaling).

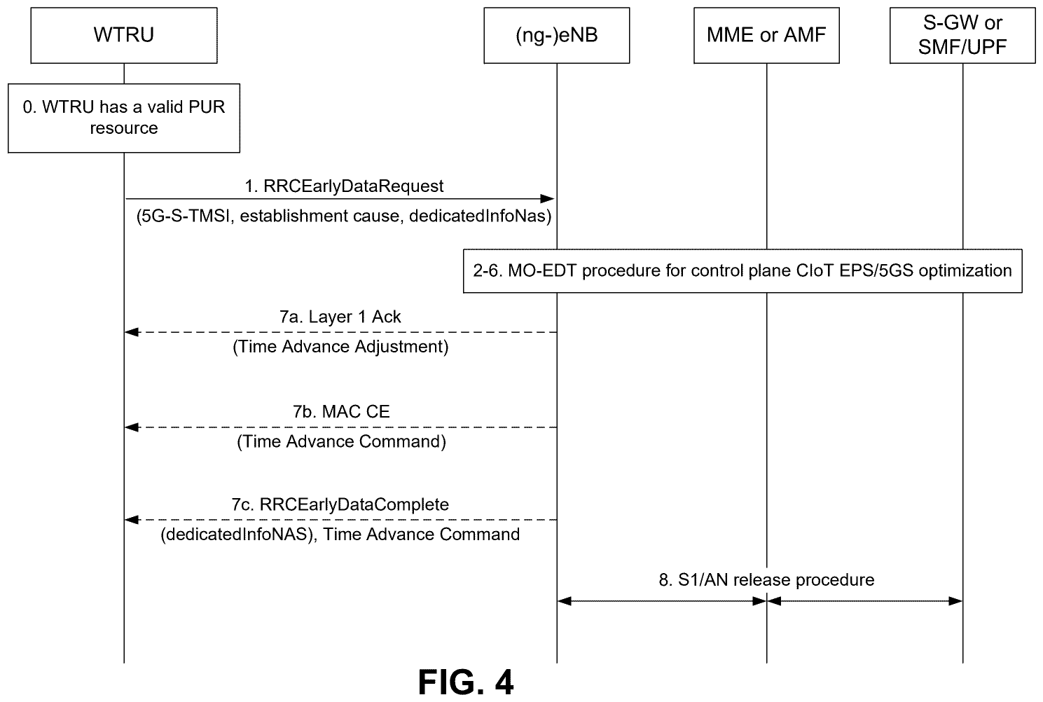

FIG. 4 illustrates example signaling in an NTN based on the example(s) described herein. One or more processes illustrated in FIG. 4 may or may not be performed (e.g., skipped).

The WTRU may perform one or more of the following actions to send a transmissions on a configured (e.g., preconfigured) uplink resource. Example(s) described herein may be described in the context of an NB-IoT device operating in an IoT-NTN (e.g., satellite based) network. The examples(s) provided herein may equally apply to any type of device operating on any network (e.g., an LTE device, eMTC device, NR device, and/or the like). The network node may be satellite-based, or a terrestrial network (e.g., an eNB, gNB, and/or like), a relay node, airborne, moving, or fixed.

Example(s) described herein may relate to transmission via preconfigured uplink resources. Example(s) described herein may equally apply to other preconfigured resources (e.g., configured grant(s) and/or semi-persistent scheduling).

Example PUR configurations are provided herein.

A WTRU may be configured (e.g., preconfigured) with one or more uplink resources (e.g., resources in which a WTRU may use to perform an uplink transmission). The WTRU receiving a configuration for one or more uplink resources for a future transmission may be referred to as having a preconfigured uplink resource or PUR. Example(s) associated with PUR configuration, validity, and/or applicability across multiple cells may be described herein.

The WTRU may receive an indication/configuration of preconfigured uplink resource(s).

The WTRU may receive a configuration for transmission on one or more uplink resources. The configuration may be received, e.g., in response to a request, such as an explicit request, for resources (e.g., a PUR-Setup request or a scheduling request), based on network scheduling, or based on information broadcast in system information.

The WTRU may receive a dedicated configuration enabling selection of one or more preconfigured uplink resources. For example, the WTRU may receive an RRC reconfiguration. The RRC reconfiguration may include the configuration for the current cell and/or one or more other cells. The WTRU may receive a PUR configuration in a message, such as an RRC Connection Release message.

The WTRU may (e.g., additionally or alternatively) receive a broadcast configuration in system information. The broadcast configuration may include the configuration of one or more resources which may be used in the current cell (e.g., the cell on which the system information may be received and/or a PUR transmission may occur).

The broadcast configuration may be used in conjunction with a dedicated configuration previously received. For example, the WTRU may be configured with dedicated PUR resources using dedicated signaling, and/or contention-based PUR resources using broadcast signaling.

One or more parameters (e.g., specific parameters) may be provided in dedicated signaling. Parameters (e.g., default parameters) may be provided in broadcast signaling. If the WTRU has not received a dedicated configuration, the WTRU may use the values provided in broadcast signaling. If the WTRU has received a dedicated configuration, the WTRU may use the values provided by the dedicated signaling.

Any combination of parameters and configurations may be allowed by combining broadcast and dedicated signaling.

A PUR occasion may refer to a set of time/frequency resources or resource blocks in which a WTRU may perform an uplink transmission. A PUR configuration may include one or more parameters to control the uplink transmission, transmission handling, and/or describe one or more transmission occasions. A configuration for a preconfigured uplink resource (PUR) may include, for example, one or more of the following: a time or time period to transmit; a frequency or frequency range to transmit; one or more resource blocks (RB) s; a modulation/coding scheme (MCS) to apply during the transmission; a carrier and/or subcarrier; a narrowband physical downlink control channel (NPDCCH) configuration; a cyclic shift value for a physical uplink shared channel (NPUSCH); the number of repetitions for NPUSCH; the number of occasions to perform PUR; a periodicity for PUR occasions and a time offset until the first PUR occasions; a PUR response window timer; a PUR time alignment timer value; an orthogonal cover code (OCC) configuration (e.g., a specific OCC to use or a set of OCC configurations to select one or more from to use when performing a PUR transmission); a cell or list of cells in which the PUR resource is valid; and/or the like.

A preconfigured uplink resources may be dedicated (e.g., reserved only for a WTRU or a set of WTRU(s) or shared (e.g., the resources may be shared among multiple WTRUs). Whether one or more preconfigured uplink resource(s) is shared or dedicated may be indicated (e.g., explicitly indicated within the PUR configuration), or may be determined (e.g., implicitly determined via the signaling method). A set of PUR resources received via dedicated signaling may be considered/assumed as dedicated. A set of PUR resources received via broadcast signaling may be considered/assumed as shared. A dedicated set of resources may be considered as contention free. A shared set of resources may be considered as contention based.

The WTRU may be configured to transmit a random access preamble if the WTRU is using a contention based PUR resource (e.g., to transmit a random access preamble then to transmit using a PUR PUSCH). A set of random access may be reserved for use with contention based PUR. The random access preambles may be associated with certain PURs. A WTRU may be configured to select a random access preamble (e.g., and PUR) from a set that is configured for use when performing a contention-based PUR transmission. The WTRU may be configured with (e.g., both) dedicated and contention based PUR. The WTRU may select which PUR to use based on one or more conditions.

Example validity criteria for preconfigured uplink resources across one or more cells are provided herein.

A PUR configuration and/or PUR transmission occasion may be associated with one or more validity conditions. If the WTRU determines that a PUR configuration or PUR occasions is valid, the WTRU may use the PUR for uplink transmission. Otherwise, the WTRU may not use the PUR for uplink transmissions. The WTRU may evaluate the validity of a PUR and/or PUR configuration, for example, during one or more of the following occasions.

The WTRU may evaluate the validity of a PUR and/or PUR configuration prior to a transmission occasion (e.g., prior to a transmission occasion, the WTRU may evaluate the validity conditions and may perform a transmission during the occasion if the validity condition(s) is met).

The WTRU may evaluate the validity of a PUR and/or PUR configuration periodically (e.g., the WTRU may periodically evaluate if the validity conditions are satisfied and, and if satisfied, the WTRU may consider one or more (e.g., all) transmission occasions as valid until the next validity evaluation).

The WTRU may evaluate the validity of a PUR and/or PUR configuration upon network request.

The WTRU may evaluate the validity of a PUR and/or PUR configuration upon reception and/or modification of a PUR configuration.

The WTRU may evaluate the validity of a PUR and/or PUR configuration upon cell reselection.

One or more validity conditions and/or parameters to evaluate the validity conditions (e.g., thresholds, durations, etc.) may be provided, for example, within the PUR configuration. A validity condition may be one or more of the following: the RSRP exceeding a threshold (e.g., the WTRU may use a PUR if the RSRP exceeds a threshold); a time or time duration (e.g., the WTRU may consider a PUR configuration as valid for a specific time period); a number of skipped transmission occasions (e.g., the WTRU may consider the PUR configuration as invalid if the WTRU skips a configured number of PUR occasions); the distance of a WTRU exceeding a threshold (e.g., the WTRU has travelled greater than a distance threshold from the time it received the PUR configuration); the distance of the WTRU and a satellite exceed a threshold; the distance of the WTRU and a reference point exceeding a threshold; the WTRU location information becoming invalid (e.g., the GNSS location information for a WTRU has expired or has become out of date); the WTRU location information being received longer than X time ago (e.g., the WTRU received the GNSS location information greater than a time period ago); the WTRU changing cells (e.g., the WTRU performs mobility and/or cell reselection to a cell other than the cell which the provided the PUR configuration); the WTRU changing to a specific cell or set of cells (e.g., the WTRU performs mobility and/or cell reselection to a specific cell and/or set of cells); the WTRU changed satellite orbits (e.g., the WTRU has transitioned from a GSO to NGSO satellite); the WTRU performs an RRC state transition (e.g., the WTRU transitions to RRC connected or RRC IDLE); a number of times a particular type of PUR resource has been used (e.g., if contention based PUR has been used X times); a failure condition associated with a PUR transmission (e.g., contention failure when using a contention-based PUR); a timing advance (TA) condition; and/or the like.

For example, the WTRU may use a dedicated PUR if the WTRU currently has a valid TA for that cell. Otherwise, the WTRU may use contention based PUR (e.g., and transmit a random access (RA) preamble before transmitting using NPUSCH).

If the WTRU determines that a PUR resource is not valid/unavailable (e.g., one or more validity criteria is not satisfied), the WTRU may perform one or more of the following actions: skip one or more UL transmission occasion(s) (e.g., not transmit on the uplink resources); release the PUR configuration; send an indication to the network; apply an alternative PUR configuration (e.g., the WTRU may switch from a dedicated PUR configuration to a shared configuration); and/or perform RACH-based EDT.

A WTRU may receive additional assistance information to evaluate the validity of a PUR configuration and/or resource. Examples of assistance information may include, for example, one or more of the following: a reference point, satellite ephemeris data (e.g., satellite location, direction, speed, and/or orbital parameters); epoch time of satellite assistance information; satellite footprint information (e.g., radius of cell footprint); WTRU location information (e.g., GNSS information); t-Service; t-serviceStart; and/or the like.

The assistance information may be related to the current serving cell, one or more neighboring cells, and/or one or more neighboring satellites. The assistance information may be received as part of the PUR configuration, or separately (e.g., via RRC signaling, MAC CE, DCI, PDSCH, PDCCH, system information, or NAS signaling).

Preconfigured uplink resources may be used across one or more cells.

A PUR configuration may be valid/available (e.g., PUR occasions and the PUR configuration may be used) in more than one cell. Whether a PUR configuration applies to a cell or set of cells may be (e.g., explicitly) indicated. The WTRU may receive an indication from the serving cell that the configuration may be applied in a target cell. The WTRU may send a transmission to a target/neighbor cell (e.g., upon cell reselection) requesting to use a PUR configuration within the cell. If the network confirms that the current PUR configuration is applicable, the WTRU may continue to use the configuration. The PUR configuration may include a list (e.g., an explicit list) of cells (e.g., PCI). The WTRU may assume that a PUR configuration may be used on a cell (e.g., via a PCI) indicated within the configuration.

The WTRU may use a PUR configuration based on the characteristics of the configuration. For example, a cell may indicate (e.g., via dedicated signaling or broadcast signaling) a set of supported PUR characteristics. If the PUR configuration maintained by the WTRU is supported by the cell, the WTRU may continue to use the PUR configuration. For example, the cell may indicate that the cell supports PUR with one or more of: a specific periodicity or set of periodicities, MCS, NPDCCH configurations, cyclic shift values, NPUSCH repetitions, time offset values, PUR response window, or PUR time alignment timer values.

The cell may indicate (e.g., via dedicated or broadcast signaling) that the cell supports a specific resource or set of resource(s) for PUR. The WTRU may use one or more preconfigured uplink resources within the PUR configuration that match the resource(s) indicated by the cell. For example, the cell may indicate that the cell supports PUR on: a carrier or subcarrier(s), a time period, a frequency, or range of frequencies.

The cell may indicate an index or set of indices associated with resources. The WTRU may use (e.g., perform an uplink transmission) on one or more PUR occasions that correspond to the index or indices that are supported by the cell.

The WTRU may determine (e.g., implicitly determine) the cells on which the PUR configuration is valid. For example, based on the configured PUR periodicity, the neighbor cell satellite ephemeris, position information, and/or the satellite t-Service and/or t-ServiceStart, the WTRU may determine which satellite or satellites are in coverage during a given PUR transmission occasion (e.g., and therefore which cells on which the PUR resource is valid).

A cell may indicate the number of WTRU-ID bits to use for determining a resource. For example, a cell may indicate X least significant bits (LSBs) of the WTRU-ID should be used to select a PUR resource (e.g., in a similar way to selection of a paging occasion based on SFN and WTRU-ID). If the list of PUR resources is of length Y, the WTRU may select the index N (e.g., in the range 0 . . . Y−1) of the PUR resource satisfying N=Y MOD X.

Configured (e.g., preconfigured) uplink resources may be modified (e.g., upon cell reselection or mobility).

One or more aspects (e.g., parameters) of the PUR configuration and/or resources reserved for PUR may be applicable to a neighboring cell. Upon cell reselection or mobility, the WTRU may determine which configuration aspects and/or PUR resources are applicable to the new cell. The WTRU may determine which configuration aspects and/or PUR resources are applicable to the new cell based on an indication, such as an explicit indication (e.g., the network indicates the current PUR configuration is invalid). The WTRU may determine (e.g., implicitly determine) which configuration aspects and/or PUR resources are applicable to the new cell (e.g., one or more aspects of the PUR configuration or resources do not match the indicated set of parameters or resources supported by the cell).

The WTRU may request a PUR configuration (e.g., or reconfiguration). For example, upon the WTRU detecting (e.g., via explicit indication or implicitly) that the current PUR configuration is not valid in the current cell, the WTRU may request a PUR configuration (e.g., reconfiguration) and transmit a PURConfigurationRequest. The WTRU may release the current configuration and receive another configuration (e.g., an entirely new configuration).

The WTRU may indicate the one or more parameters of the current PUR configuration (e.g., the parameter(s) that need reconfiguration). The WTRU may wait for the network to update the invalid parts of the configuration. The WTRU may receive a delta configuration from the neighboring cell. For example, the parameters within the partial/delta configuration may override the parameters used within the current serving cell. The WTRU may assume that one or more parameters not included within the partial/delta configuration apply to the current serving cell.

The WTRU may update (e.g., autonomously update) the aspects of the PUR configuration. For example, upon detecting that one or more aspects of a PUR configuration are not supported by the cell (e.g., based on explicit indication or implicitly), the WTRU may adjust (e.g., update) the aspects of the PUR configuration to aspects that are supported by the cell. The WTRU may apply the new and/or updated PUR configuration (e.g., upon connection to the target cell, or upon confirmation from the target cell that the PUR configuration is supported/may be applied). The cell may configure whether the WTRU is able to autonomously update the PUR configuration (e.g., based on indication in system information).

The WTRU may have a rule to map one or more aspects from one cell to another. For example, the WTRU may map the current PUR occasions based on the WTRU-ID. For example, a cell may indicate X LSBs of the WTRU-ID are to be used to select a PUR occasion (e.g., in a similar way to selection of a paging occasion based on SFN and WTRU-ID). If a list of PUR resources is of length Y, the WTRU may select the index N (e.g., in the range 0 . . . Y−1) of the PUR resource satisfying N=Y MOD X. The WTRU may receive a configuration (e.g., an explicit configuration) of an index (e.g., N), for example, using dedicated signaling in a first cell. The WTRU may receiver a list of resources in a second cell. The WTRU may select the resource (e.g., with index N that was assigned in the first cell) to use in the second cell.

The resource or set of resources the WTRU selection may be based on a priority (e.g., a device or transmission priority). The priority may be assigned to the WTRU upon PUR configuration. The priority may be determined for a given PUR transmission. For example, if a WTRU attempts a contention based PUR transmission, but fails to successfully compete the procedure, a subsequent attempt may use a higher priority of transmission (e.g., such that the WTRU selects from a higher priority set of resources that may have a lower probability of contention failure).

The WTRU may receive more than one PUR configurations. The PUR configuration may be for an upcoming neighbor cell. A PUR configuration associated with an upcoming cell may be associated with an activation time and/or activation condition (e.g., the WTRU may apply the configuration upon connecting to a cell). The PUR configuration may be associated with an index value. A cell may broadcast one or more indices associated with a PUR configuration that the cell supports. The WTRU may apply a (e.g., any) configuration index that is supported by the cell.

The WTRU may receive a default PUR configuration. Upon cell reselection or mobility, the WTRU may apply a default PUR configuration. The WTRU may (e.g., continue to) use the default PUR configuration until updated parameters (e.g., dedicated configuration) are received. The WTRU may receive an indication of whether the WTRU is to use a default configuration (e.g., via system information).

The WTRU may modify the uplink resources used for PUR transmission (e.g., using the same or similar methods as described herein, instead of modifying aspects of the PUR configuration).

Configured (e.g., preconfigured) uplink resources may be signaled.

The WTRU may receive, via broadcast signaling (e.g., via system information) and/or via dedicated signaling (e.g., via RRC signaling, MAC CE, DCI, PDSCH, PDCCH, or NAS signaling), a PUR configuration, indication of PUR resources, and/or assistance information to determine the validity of a PUR configuration and/or PUR occasion.

The WTRU may receive one or more aspects of a PUR configuration via different signaling methods. For example, the WTRU may receive a first (e.g., one) set of parameters of a PUR configuration via dedicated signaling, and a second set of parameters via broadcast signaling. If a parameter is provided by (e.g., both) dedicated and broadcast signaling, the WTRU may select the value to apply (e.g., based on one or more of the following rules).

If a parameter is provided by (e.g., both) dedicated and broadcast signaling, the WTRU may apply (e.g., always apply) the value received via dedicated signaling.

If a parameter is provided by (e.g., both) dedicated and broadcast signaling, the WTRU may apply (e.g., always apply) the most recent value.

If a parameter is provided by (e.g., both) dedicated and broadcast signaling, the WTRU may select a value based on WTRU implementation.

If a parameter is provided by (e.g., both) dedicated and broadcast signaling, the WTRU may select a value based on the data to be transmitted.

If a parameter is provided by (e.g., both) dedicated and broadcast signaling, the WTRU may select a value based on any of the criteria that are available to be used for preconfigured uplink resource selection.

The WTRU may receive some aspects (e.g., parameters) of a PUR configuration via a first cell and other aspects (e.g., parameters) of a PUR configuration via a second cell. For example, the WTRU may receive an authorization to use shared PUR resources from a first cell. The WTRU may receive the configuration of the shared PUR resources from a second cell. If the WTRU has been authorized (e.g., enabled) to use shared PUR resources, and the current cell broadcasts a shared PUR configuration, the WTRU may initiate PUR transmission using the configured shared PUR resources.

A WTRU may perform preconfigured uplink resource selection.

The WTRU may (e.g., upon cell reselection or mobility to a different cell) maintain a PUR configuration. The WTRU may perform an uplink transmission on a second cell using a PUR configuration received in a first cell. The WTRU may select between one or more configurations and/or transmission occasions. The WTRU may determine a valid transmission occasion (e.g., via example(s) described herein).

The WTRU may select dedicated preconfigured uplink resources upon cell change.

The WTRU may receive a PUR configuration from a first cell (e.g., that may include a dedicated set of resources for uplink transmission). The WTRU may change cells (e.g., via cell reselection and/or mobility) to a second cell. The WTRU may determine whether the WTRU is to continue using the PUR configuration (e.g., the dedicated set of resources) in the second cell by verifying the validity of the PUR configuration and dedicated resources in the second cell. The WTRU may determine the PUR configuration is valid in the second cell, for example, via explicit indication in the PUR configuration (e.g., the PCI of the second cell is included in the PUR configuration), via characteristics of the second cell (e.g., that the cell originates from the same satellite), or via configuration information indicated by the second cell (e.g., a list of resources dedicated for PUR or PUR configurations supported by the cell). The information to evaluate whether the PUR configuration is valid in the second cell may be broadcast, or sent via dedicated signaling (e.g., in response to a request from the WTRU).

Upon determination that at least one PUR occasion (e.g., dedicated resource) is valid in the second cell, the WTRU may perform verification (e.g., additional verification) that the WTRU may use the dedicated resources for PUR based on additional validity criteria (e.g., the WTRU satisfies time, location, distance, measurement requirements to use PUR, as described elsewhere within this document). The WTRU may receive (e.g., additional) assistance information to evaluate the validity criteria, such as satellite assistance information (e.g., satellite ephemeris) or characteristics of the second cell (e.g., reference points, footprint information, etc.).

Upon determining that the WTRU satisfied all validity criteria to use the dedicated PUR resources in a second cell, the WTRU may perform and uplink transmission in using the dedicated resources (e.g., an early data transmission (EDT) request).

The WTRU may select a shared preconfigured uplink resource.

The WTRU may not be able to use dedicated PUR resources in a second cell. For example, the second cell may not support the dedicated resources within the PUR configuration from the first cell or the second cell does not support dedicated resources for PUR. The WTRU may use (e.g., instead use) a set of shared PUR resources. The WTRU may determine the set of shared resources based on an indication from the second cell (e.g., via broadcast signaling, or dedicated signaling). A shared resource indication may include one or more of the following: a time or time period to transmit; a frequency or frequency range to transmit; and/or one or more resource blocks (RBs).

The WTRU may select which resource among the shared set of PUR resources supported by the second cell based on, for example, one or more of the following techniques.

The WTRU may select the first available transmission occasion.

The WTRU may select the first occasion suitable for the uplink data to be transmitted (e.g., with a suitable size of resources available to fit the transmission in).

The WTRU may select (e.g., randomly select) a shared PUR resource.

The WTRU may select based on the WTRU ID (e.g., the WTRU uses one or more digits from the WTRU ID to select a transmission occasion).

The WTRU may select the resource based on the WTRU circumstances. For example, the WTRU may select from a different set of shared resources based on the distance of the WTRU from a reference point, based on the measured RSRP, based on the current time, etc.

Whether the WTRU is capable of using a shared PUR resource may be based on one or more other aspects of the PUR configuration (e.g., the second cell PCI being included within the PUR configuration, other parameters of the PUR configuration like periodicity being supported by the second cell, etc.).

Upon determining that the WTRU satisfied one or more (e.g., all) validity criteria to use the shared PUR resources in a second cell, the WTRU may perform and uplink transmission in using a selected shared resources (e.g., an EDT request). The WTRU may use a specific preamble for use of PUR transmission when using the shared set of resources, e.g., to indicate that the transmission is a PUR transmission.

The WTRU may perform one or more actions upon detection of no valid PUR resource.

The WTRU may not continue using a PUR configuration in a second cell. For example, one or more aspects of the PUR configuration from the first cell may not be supported in the second cell. There may not be any shared or dedicated resources available (e.g., or supported) for the WTRU to continue the PUR configuration. In examples, the WTRU may attempt using an uplink resource, but encounter persistent transmission failure (e.g., contention failure, ACK has not been received, or timer expiry). In the case of persistent failure, the WTRU may perform RACH to support EDT transmission.

A WTRU may determine a PUSCH resource on an NTN cell based on configuration on a previous cell. The WTRU may receive dedicated configuration of a preconfigured uplink resources from a previous cell, and may determine, based on broadcast information on the new cell, a specific dedicated resource to use. The WTRU may determine to use a shared resource (e.g., contention based PUSCH) in case no dedicated configuration was received or if the dedicated resource is not valid in the new cell.

The WTRU may transmit a PUR configuration request to a first NTN cell.

The PUR configuration request may include an indication of one or more of: periodicity, no occurrences, TBS, whether an RRC ACK is preferred, and/or the like.

The WTRU may receive a configuration (e.g., enhanced PUR Configuration in RRC Release) of a preconfigured uplink resource from a first NTN cell. The PUR configuration may include an indication that the resource is valid on one or more second cells. The PUR configuration may include: an explicit list of cells (e.g., PCI); a periodicity, with implicit determination of valid cells (e.g., based on satellite ephemeris information and PUR periodicity); an index for a resource (e.g., index X); an indication of a number of WTRU-ID bits to use for determining a resource; and/or the like.

The WTRU may perform reselection to a second NTN cell.

The WTRU may receive a broadcast PUR configuration from the second cell (e.g., including dedicated and shared PUR resources).

The WTRU may determine (e.g., based on the configurations received from the first and second cell) whether the dedicated resource is valid.

The WTRU may determine whether the dedicated resource is valid based on the cell list (explicit or implicit).

The WTRU may check whether the dedicated resource is valid based on the signaled index. The WTRU may determine whether a valid resource is configured in the second cell based on the WTRU-ID (e.g., a list of dedicated resources may provide resource for some but not all indexes).

The WTRU may use additional criteria to determine whether the dedicated resource is valid. For example, the WTRU may whether the dedicated resource is valid based on whether the WTRU has estimated a valid TA, or has a valid TA available. The WTRU may whether the dedicated resource is valid based on location, time, and/or radio quality conditions.

If the WTRU determines that a valid dedicated resource is available, the WTRU may transmit an EDT request using the determined PUR.

If the WTRU determines that no valid dedicated resource is available, the WTRU may determine whether a valid shared PUR resource is available (e.g., randomly select one of a list of shared PUR resources; select based on WTRU ID; or select based on additional conditions, for example location, time or radio quality conditions).

If the WTRU determines that a valid shared PUR resource is available, the WTRU may transmit using the selected PUR resource. The WTRU may transmit a (e.g., specific) preamble. The WTRU may transmit a payload using PUSCH.

If the WTRU determines that no valid shared PUR resource is available, or if the WTRU detects a failure (e.g., contention failure, no ACK, etc.), the WTRU may perform RACH for the EDT transmission.

The WTRU may receive an indication, such as L1 ACK, MAC CE, RRCEarlyDataComplete, and/or the like, to terminate the procedure.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-16. (canceled)

17. A wireless transmit/receive unit (WTRU), comprising:
a processor configured to:
receive a broadcast signal from a non-terrestrial network (NTN), wherein the broadcast signal comprises an indication of a set of shared resources;
determine that a plurality of shared resources, in the set of shared resources, are associated with respective reference signal received powers (RSRPs) that are greater than a threshold;
select a shared resource from the plurality of shared resources;
perform a contention-based channel access procedure associated with the shared resource; and
on a condition that the contention-based channel access procedure is successful, send an uplink message to the NTN via the shared resource.

18. The WTRU of claim 17, wherein the processor being configured to select the shared resource from the plurality of shared resources comprises the processor being configured to randomly select the shared resource from the plurality of shared resources.

19. The WTRU of claim 17, wherein the uplink message is a first uplink message, and the processor is further configured to:
determine, for a second uplink message, that no shared resource in the set of shared resources is associated with an RSRP above a threshold; and
based on the determination that no shared resource in the set of shared resources is associated with RSRP above the threshold, perform a random access channel (RACH) procedure for an early data transmission of the second uplink message.

20. The WTRU of claim 17, wherein the broadcast signal further indicates one or more of a time at which to perform the contention-based channel access procedure, a frequency at which to send the uplink message, a frequency range in which to send the uplink message, or one or more resource blocks in which to send the uplink message.

21. The WTRU of claim 17, wherein the contention-based channel access procedure is a first contention-based channel access procedure, the contention-based channel access procedure is performed using a first transmission priority, and the processor is further configured to, on a condition that the first contention-based channel access procedure fails, perform a second contention-based channel access procedure using a second transmission priority, wherein the second transmission priority is higher than the first transmission priority.

22. The WTRU of claim 17, wherein the contention-based channel access procedure is a first contention-based channel access procedure, the set of shared resources is a first set of resources associated with a first priority, and the processor is further configured to, on a condition that the first contention-based channel access procedure fails, perform a second contention-based channel access procedure using a second set of resources, wherein the second set of resources is associated with a second priority, and wherein the second priority is higher than the first priority.

23. The WTRU of claim 17, wherein the processor is configured to determine that a dedicated resource is unavailable or unsupported by the NTN, wherein the processor being configured to select the shared resource comprises the processor being configured to select the shared resource in response to determining that the dedicated resource is unavailable or unsupported by the NTN.

24. The WTRU of claim 17, wherein the broadcast signaling comprises system information, and wherein the system information comprises the indication of the set of shared resources.

25. The WTRU of claim 17, wherein the processor is further configured to:
based on the uplink message being sent in the shared resource, select a random access preamble; and
send the random access preamble to the NTN.

26. A method performed by a wireless transmit/receive unit (WTRU), comprising:
receiving a broadcast signal from a non-terrestrial network (NTN), wherein the broadcast signal comprises an indication of a set of shared resources;
determining that a plurality of shared resources, in the set of shared resources, are associated with respective reference signal received powers (RSRPs) that are greater than a threshold;
selecting a shared resource from the plurality of shared resources;
performing a contention-based channel access procedure associated with the shared resource; and
on a condition that the contention-based channel access procedure is successful, sending an uplink message to the NTN via the shared resource.

27. The method of claim 26, wherein selecting the shared resource from the plurality of shared resources comprises randomly selecting the shared resource from the plurality of shared resources.

28. The method of claim 26, wherein the uplink message is a first uplink message, and the method further comprises:
determining, for a second uplink message, that no shared resource in the set of shared resources is associated with an RSRP above a threshold; and
based on the determination that no shared resource in the set of shared resources is associated with RSRP above the threshold, performing a random access channel (RACH) procedure for an early data transmission of the second uplink message.

29. The method of claim 26, wherein the broadcast signal further indicates one or more of a time at which to perform the contention-based channel access procedure, a frequency at which to send the uplink message, a frequency range in which to send the uplink message, or one or more resource blocks in which to send the uplink message.

30. The method of claim 26, wherein the contention-based channel access procedure is a first contention-based channel access procedure, the contention-based channel access procedure is performed using a first transmission priority, and the method further comprises, on a condition that the first contention-based channel access procedure fails, perform a second contention-based channel access procedure using a second transmission priority, wherein the second transmission priority is higher than the first transmission priority.

31. The method of claim 26, wherein the contention-based channel access procedure is a first contention-based channel access procedure, the set of shared resources is a first set of resources associated with a first priority, and the method further comprises, on a condition that the first contention-based channel access procedure fails, perform a second contention-based channel access procedure using a second set of resources, wherein the second set of resources is associated with a second priority, and wherein the second priority is higher than the first priority.

32. The method of claim 26, wherein the method further comprises determining that a dedicated resource is unavailable or unsupported by the NTN, wherein selecting the shared resource comprises selecting the shared resource in response to determining that the dedicated resource is unavailable or unsupported by the NTN.

33. The method of claim 26, wherein the broadcast signaling comprises system information, and wherein the system information comprises the indication of the set of shared resources.

34. The method of claim 26, wherein the method further comprises:
based on the uplink message being sent in the shared resource, selecting a random access preamble; and
sending the random access preamble to the NTN.
